(19) United States
(12) Patent Application Publication
(10) Pub. No.: US 2012/0075842 A1
(43) Pub. Date: Mar. 29, 2012

(54) LIGHTING SYSTEM FOR A CUP HOLDER ASSEMBLY

(75) Inventor: KAZUHIRO GOTO, MARKHAM (CA)

(73) Assignee: TYCO ELECTRONICS CANADA, ULC, MARKHAM (CA)

(21) Appl. No.: 12/889,812

(22) Filed: Sep. 24, 2010

(51) Int. Cl. F21V 33/00; B65D 25/00

(52) U.S. Cl. 362/154; 220/737

(57) ABSTRACT

A cup holder is provided. The cup holder includes a body having bottom wall and a sidewall extending from the bottom wall. A cavity is defined by an interior surface of the bottom wall and an interior surface of the sidewall. A power source is joined to an exterior surface of the bottom wall of the body. The exterior surface of the bottom wall of the body is opposite the interior surface of the bottom wall of the body. A LED is electrically coupled to the power source. A reflective surface is configured to direct light from the LED along the bottom wall of the body.

### BACKGROUND OF THE INVENTION

The subject matter described herein relates generally to a lighting system and, more particularly, to a lighting system for a cup holder.

Vehicles typically include cup holders to retain beverages while the vehicle is being operated. However, many conventional cup holders are difficult to see. In particular, the cup holder may be difficult to see while driving in the evening. Some cup holders have a dark color to match an interior of the vehicle. The dark color of the cup holder further limits a driver's ability to see the cup holder. Inability to see the cup holder may result in beverages being spilled in the vehicle. A spilled beverage may damage the interior of the vehicle. Additionally, a spilled beverage may result in an accident and/or serious injury.

Some lighting systems have been incorporated into conventional cup holders. The lighting systems may include a ring of lights around an exterior of the cup holder. Other lighting systems include illuminated discs that are positioned within the cup holder. The illuminated discs are joined to a cable that plugs into a power source of the vehicle, for example, a cigarette lighter.

However, conventional lighting systems for cup holders are not without their disadvantages. Some conventional lighting systems only illuminate an edge around the cup holder. Accordingly, the cavity of the cup holder is not illuminated. Such lighting systems may not illuminate objects that are already positioned within the cup holder. Placing a beverage into a cup holder having an object therein may result in the beverage spilling.

Other lighting systems are not built into the cup holder. These lighting systems include cords and wires that extend from the cup holder. The cords and wires may clutter the interior of the vehicle. The cords and wires may also create difficulty when placing a beverage into the cup holder. Additionally, the cords and wires may interfere with the driver's ability to operate the vehicle, thereby resulting in an accident.

A need remains for a lighting system that is built into a cup holder and illuminates a cavity of the cup holder.

### SUMMARY OF THE INVENTION

In one embodiment, a cup holder is provided. The cup holder includes a body having bottom wall and a sidewall extending from the bottom wall. A cavity is defined by an interior surface of the bottom wall and an interior surface of the sidewall. A power source is joined to an exterior surface of the bottom wall of the body. The exterior surface of the bottom wall of the body is opposite the interior surface of the bottom wall of the body. A LED is electrically coupled to the power source. A reflective surface is configured to direct light from the LED along the bottom wall of the body.

In another embodiment, a cup holder is provided. The cup holder includes a body having a bottom wall and a sidewall. A cavity is defined by an interior surface of the bottom wall of the body and an interior surface of the sidewall of the body. A power source is joined to bottom wall of the body. A LED is electrically coupled to the power source. An insert is positioned on the interior surface of the bottom wall of the body. The insert has a reflective surface formed therein. The reflective surface directs light from the LED through the insert.

In another embodiment, a lighting system for a cup holder is provided. The lighting system includes a power source configured to join to an exterior surface of a bottom wall of the cup holder. A LED is electrically coupled to the power source. An insert is configured to position on an interior surface of the bottom wall of the cup holder. The insert has a reflective surface formed therein. The reflective surface directs light from the LED through the insert.

### BREIF DESCRIPTION OF THE DRAWINGS

FIG. 1 is an exploded front view of a cup holder assembly formed in accordance with an embodiment

FIG. 2 is a cut-away side view of the cup holder assembly shown in FIG. 1.

FIG. 3 is an expanded view of the area 3 shown in FIG. 2.

FIG. 4 is an expanded view of the area 4 shown in FIG. 2.

FIG. 5 is a bottom perspective view of a cup holder assembly formed in accordance with an alternative embodiment.

FIG. 6 is a cut-away side view of the cup holder assembly shown in FIG. 5 taken along line 6-6 of FIG. 5.

FIG. 7 is a cross-sectional view of a cup holder assembly formed in accordance with an alternative embodiment.

FIG. 8 is an expanded view of the area 8 shown in FIG. 7.

### DETAILED DESCRIPTION OF THE DRAWINGS

The foregoing summary, as well as the following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

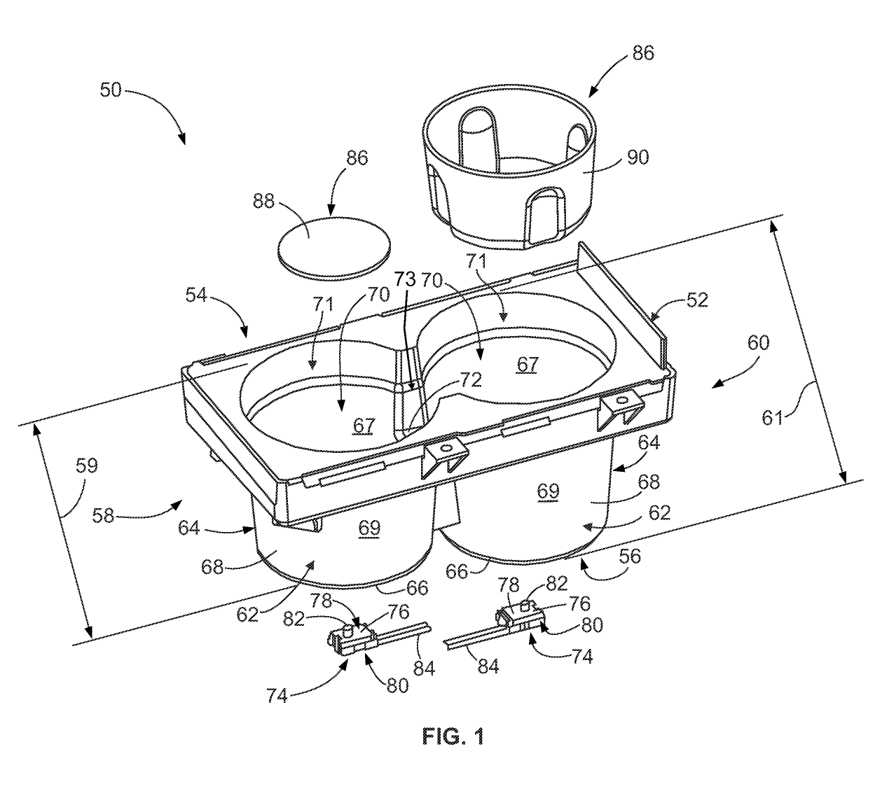

FIG. 1 illustrates a cup holder assembly 50. The cup holder assembly 50 includes a housing 52. The housing 52 has a top 54 and a bottom 56. The housing 52 includes a first end 58 and a second end 60. The housing 52 is configured to be inserted into a vehicle (not shown) or the like. The housing 52 may be inserted into a console (not shown) of a vehicle. The housing 52 includes two cup holders 62. In another embodiment, the housing 52 may include any number of cup holders 62. In the illustrated embodiment, the cup holders 62 are positioned adjacent one another.

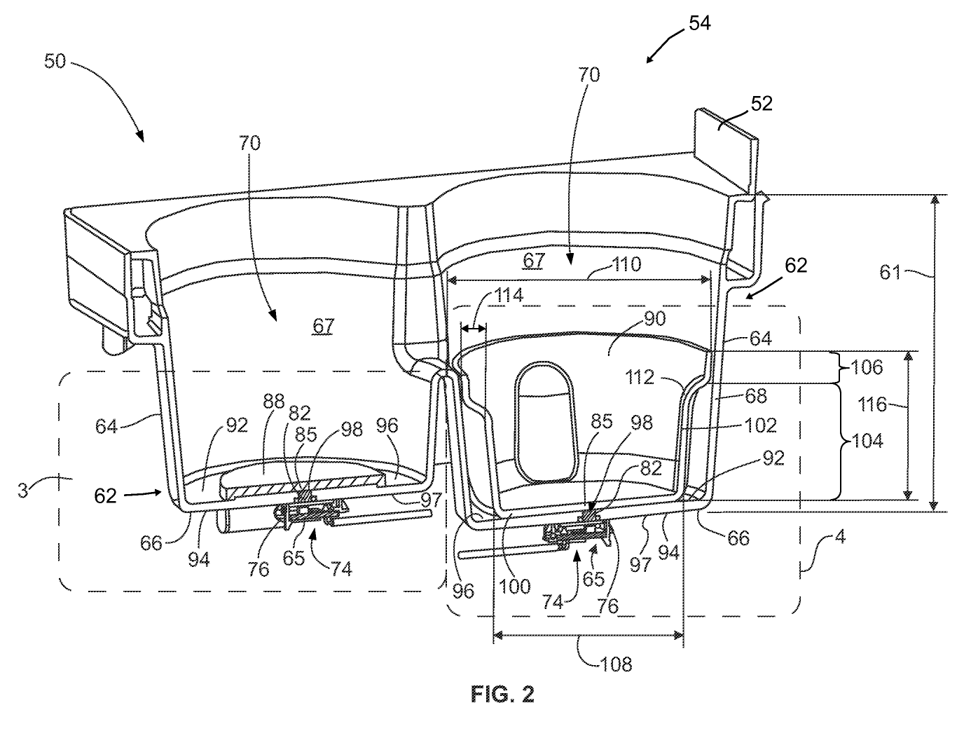

Each cup holder 62 includes a body 64. The body 64 includes a bottom wall 66 and a sidewall 68. The bottom wall 66 has a circular shape including a center 65 (shown in FIG. 2). The bottom wall 66 of the cup holder 62 is positioned at the bottom 56 of the housing 52. The bottom wall 66 includes an exterior surface 97 (shown in FIG. 2). The sidewall 68 of the cup holder 62 extends from the bottom wall 66 of the cup holder 62. The sidewall 68 has a conical configuration. Alternatively, the sidewall 68 may have any suitable shape, for example, circular, squared, or the like. The sidewall 68 includes an interior surface 67 and an exterior surface 69. The bottom wall 66 of the cup holder 62 and the sidewall 68 of the cup holder 62 define a cavity 70. The interior surface 67 of the sidewall 68 defines a side of the cavity 70. The cavity 70 has an opening 71 at the top 54 of the housing 52. The opening 71 extends through the top 54 of the housing 52. The cavity is configured to retain a container, such as a cup (not shown), therein.

One cup holder 62 is positioned adjacent the first end 58 of the housing 52. Another cup holder 62 is positioned adjacent the second end 60 of the housing 52. The cavities 70 of the cup holders 62 are divided by a partition 72. The partition 72 extends from the bottom 56 of the housing 52 partially to the top 54 of the housing 52. The cavities 70 are separated by a gap 73 proximate to the top 54 of the housing 52. The gap 73 is oriented above the partition 72. The cavity 70 of the cup holder 62 adjacent the first end 58 has a depth 59 defined between the top 54 of the housing 52 and the bottom wall 66 of the cup holder 62. The cavity 70 of the cup holder 62 adjacent the second end 60 has a depth 61 defined between the top 54 of the housing 52 and the bottom wall 66 of the cup holder 62. The depth 61 may be greater than the depth 59. Alternatively, the depth 59 may be greater than the depth 61. In another embodiment, the depth 59 may be the same as the depth 61.

A LED assembly 74 is configured to join to the bottom wall 66 of one or each cup holder 62. The LED assembly 74 is coupled to the exterior surface 97 (shown in FIG. 2) of the bottom wall 66. The LED assembly 74 includes a power source 76. The power source 76 may be a battery or the like. The power source 76 includes an LED surface 78 and a bottom surface 80. The LED surface 78 of the power source 76 is joined to the exterior surface 97 of the bottom wall 66 of the cup holder 62. One or more LEDs 82 are coupled to the LED surface 78 of the power source 76. The LED 82 is powered and controlled by the power source 76. The LED 82 is configured to illuminate the cavity 70 of the respective cup holder 62. At least one lead 84 extends from the power source 76. In the illustrated embodiment, the lead 84 is joined to the power source 76 proximate to the bottom surface 80 of the power source 76. Alternatively, leads 84 may extend from the bottom surface 80 and/or the LED surface 78 of the power source 76. The leads 84 are configured to join to a power system (not shown) of the vehicle to power the power source 76. The power source 76 may include a rechargeable battery that is charged by the power system of the vehicle. The power source 76 may be joined to a switch that operates the LED assembly 74. The LED assembly 74 is configured to be housed within an interior portion of the vehicle. For example, the LED assembly 74 may be housed within a console (not shown) of the vehicle. The LED assembly 74 is configured to be isolated from an operator of the vehicle.

Inserts 86 are configured to be positioned within the cavity 70 of each cup holder 62. The inserts 86 are configured to rest on the bottom wall 66 of the cup holder 62. One or more insert 86 may be formed as a disc 88 and/or as a basket 90. Optionally, the inserts 86 may each be formed with any suitable configuration that is capable of being positioned within the cavity 70. The inserts 86 are formed from a translucent and/or transparent material that is capable of transmitting light. The inserts 86 are configured to be illuminated by the LED 82. Light from the LED 82 is configured to internally reflect, within the inserts 86 such that the light propagates through the inserts 86. Light propagating through the insert 86 causes the insert to glow. The inserts 86 are configured to glow to illuminate the cavity 70 of the respective cup holder 62.

FIG. 2 illustrates a cut-away side view of the cup holder assembly 50. The bottom wall 66 of each cup holder body 64 has a first side 92 and an opposite second side 94. An interior surface 96 is formed on the first side 92 of the bottom wall 66. The exterior surface 97 is formed on the second side 94 of the bottom wall 66. An aperture 98 extends through the bottom wall 66 of the cup holder body 64. The aperture 98 extends from the first side 92 to the second side 94 of the bottom wall 66. The aperture 98 extends through the interior surface 96 and the exterior surface 97 of the bottom wall 66. The aperture 98 is oriented at the center 65 of the bottom wall 66. In one embodiment, the bottom wall 66 of the cup holder body 64 may have multiple apertures 98 extending therethrough. Multiple apertures 98 may be positioned at any location on of the bottom wall 66. For example, multiple apertures 98 may be oriented in a ring that circles the center 65 of the bottom wall 66.

An LED assembly 74 is joined to the exterior surface 97 of the bottom wall 66 of each cup holder body 64. The power source 76 of the LED assembly 74 is joined to the exterior surface 97 of the cup holder body 64. An LED 82 extends through the aperture 98. The LED 82 extends from the second side 92 to the first side 94 of the bottom wall 66 of the cup holder body 64. The LED 82 passes through the interior surface 96 and the exterior surface 97 of the bottom wall 66. The LED 82 includes a distal end 85 positioned distally from the power source 76. The distal end 85 of the LED 82 is positioned flush with the interior surface 96. Optionally, the distal end 85 of the LED 82 may extend up from the second side 94 of the bottom wall 66 past the interior surface 96 or be recessed with respect to the second side 94 of the bottom wall 66. The LED 82 emits light that illuminates the cavity 70 of the cup holder 62.

In one embodiment, more than one LED 82 may extend through the aperture 98. Alternatively, in an embodiment having more than one aperture 98, one or more LEDs 82 may extend through each of the multiple apertures 98. For example, multiple LEDs 82 may be formed in a ring that circles the center 65 of the bottom wall 66. Multiple LEDs 82 may be configured with different colors. The LEDs 82 may be selectively operable to illuminate the cavity 70 of the cup holder 62 with a desired color. Multiple LEDs 82 may be configured to operate in sequence to change a color of the cavity 70. In another embodiment, multiple LEDs 82 may operate concurrently to provide additional illumination to the cavity 70. Alternatively, multiple LEDs 82 may selectively operate in sequence, concurrently, or one or more at a time.

The disc 88 is positioned along the bottom wall 66 of the cup holder body 64. The disc 88 is centered with respect to the center 65 of the bottom wall 66. The disc 88 extends outward from the center 65 of the bottom wall 66 partially along the interior surface 96 of the cup holder 62. Alternatively, the disc 88 may extend entirely along the interior surface 96 of the cup holder 62 such that the disc 88 abuts the interior surface 67 of the sidewall 68 The disc 88 is oriented above the LED 82. In an embodiment having multiple LEDs 82, the disc 88 may be oriented above each LED 82. Alternatively, the disc 88 may be oriented above only some of the multiple LEDs 82. The disc 88 is positioned proximate to the distal end 85 of the LED 82. In one embodiment, the disc 88 may be in contact with the distal end 85 of the LED 82. The disc 88 is configured to be illuminated by the LED 82 such that light from the LED 82 propagates through the disc 88 causing the disc 88 to glow. The disc 88 illuminates the cavity 70 of the cup holder 62.

The basket 90 includes a bottom wall 100 and a sidewall 102. The sidewall 102 extends from the bottom wall 100. The basket 90 is sized and shaped so as to be positioned within the cavity 70 such that the bottom wall 100 of the basket 90 rests on the bottom wall 66 of the cup holder 62. The bottom wall 100 of the basket 90 is centered within the cavity 70 with respect to the center 65 of the bottom wall 66 of the cup holder 62. The bottom wall 100 of the basket extends outward from the center 65 of the bottom wall 66 partially along the interior surface 96 of the bottom wall 66. Alternatively, the bottom wall 100 of the basket 90 may extend entirely along the interior surface 96 such that the bottom wall 100 of the basket 90 abuts the interior surface 67 of the sidewall 68 of the cup holder 62. The bottom wall 100 of the basket 90 is oriented above the LED 82. In an embodiment having multiple LEDs 82, the bottom wall 100 of the basket 90 may be oriented above each LED 82. Alternatively, the bottom wall 100 of the basket 90 may be oriented above only some of the multiple LEDs 82. The bottom wall 100 of the basket 90 extends over the distal end 85 of the LED 82. In one embodiment, the bottom wall 100 of the basket 90 may contact the distal end 85 of the LED 82. The basket 90 is configured to be illuminated by the LED 82 such that light from the LED 82 propagates through the basket 90. The light from the LED 82 causes the basket 90 to glow and illuminate the cavity 70 of the cup holder 62.

The sidewall 102 of the basket 90 extends proximate to the interior surface 67 of the sidewall 68 of the cup holder 62. The sidewall 102 of the basket 90 includes a bottom portion 104 and a top portion 106. The bottom portion 104 is joined to the bottom 100 of the basket 90. The top portion 106 extends from the bottom portion toward the top 54 of the cup holder assembly housing 52. The bottom portion 104 has a bottom diameter 108 and the top portion 106 has a top diameter 110. The top diameter 110 may be greater than the bottom diameter 108. The bottom portion 104 tapers outward from the bottom wall 100 of the basket 90 to the top portion 106. The sidewall 102 tapers outward from the bottom diameter 108 to the top diameter 110. A transition portion 112 is formed in the bottom portion 104. The top portion 106 extends from the transition portion 112. The transition portion 112 tapers outward from the bottom portion 104 to the top portion 106.

The sidewall 102 at the bottom portion 104 of the basket 90 is positioned a distance 114 from the interior surface 67 of the sidewall 68 of the cup holder 62. The distance 114 becomes smaller as the bottom portion 104 tapers outward from the bottom wall 100 of the basket 90 to the top portion 106 of the basket 90. Alternatively, the sidewall 102 at the bottom portion 104 of the basket 90 may abut the interior surface 67 of the sidewall 68 of the cup holder 62. The sidewall 102 at the top portion 106 of the basket 90 abuts the interior surface 67 of the sidewall 68 of the cup holder 62.

The sidewall 102 of the basket 90 has a height 116. In the illustrated embodiment, the height 116 of the sidewall 102 of the basket 90 is less than the depth 61 of the cup holder 62. The basket 90 extends a portion of the depth 61 of the cup holder 62. Alternatively, the height 116 of the sidewall 102 of the basket 90 may be the same as the depth 61 of the cup holder 62 so that the basket 90 extends the entire depth 61 of the cup holder 62.

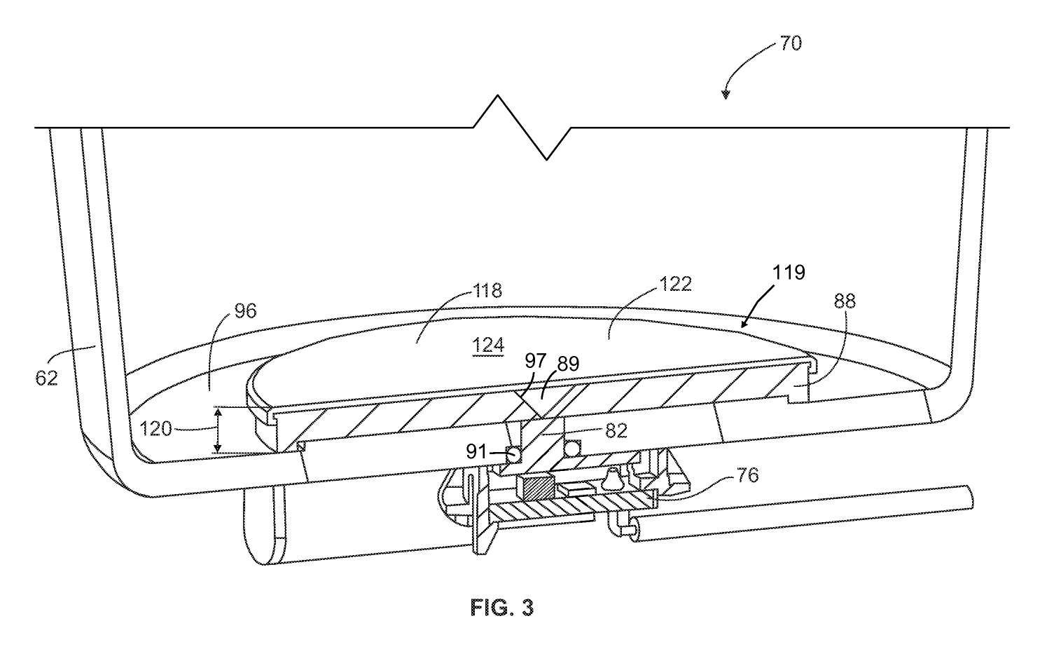

FIG. 3 illustrates an expanded view of the area 3 shown in FIG. 2. The disc 88 includes a notch 89 formed therein. In one embodiment, the notch 89 is conical. Alternatively, the notch 89 may have any suitable shape. The notch 89 includes a reflective surface 97 configured to reflect light from the LED 82. The notch 89 is aligned with the LED 82. The reflective surface 97 is located and shaped to reflect light from the LED 82 through the disc 88. For example, a conical notch 89 includes a reflective surface 97 that reflects light 360 degrees through the disc 88. The disc 88 includes a cover 118. The cover 118 is configured to limit light from the disc 88. The cover 118 may be configured with translucent and/or transparent designs and/or logos. The cover 118 may limit the light from the disc 88 such that only the designs and/or logos glow, thereby displaying the designs and/or logos within the cavity 70. The designs and/or logos may also be colored to alter a color of the light emitted by the LED 82.

The disc 88 has a height 120 extending from the interior surface 96 of the cup holder 62 to a top 122 of the cover 118. The height 120 of the disc 88 is configured so that a container can be retained within the cup holder 62 without the disc 88 interfering with the stability of the container. The top 122 of the cover 118 has a planar surface 124 that allows a container to be balanced on the disc 88 without allowing the container to move within the cup holder 62. The cover 118 and the disc 88 form a disc assembly 119. The disc assembly 119 may be formed from a water resistant material so that the cover 118 and the disc 88 are not damaged by condensation on the container and/or liquids within the container. In one embodiment, the disc 88 may form a water tight interface with the interior surface 96 of the cup holder 62 to prevent liquids from seeping under the disc 88 and damaging the LED 82 and/or the power source 76. The cup holder 62 also includes an o-ring 91 that seals the LED 82 to the cup holder 62. The o-ring 91 provides a water tight interface that prevents water damage to the power source 76.

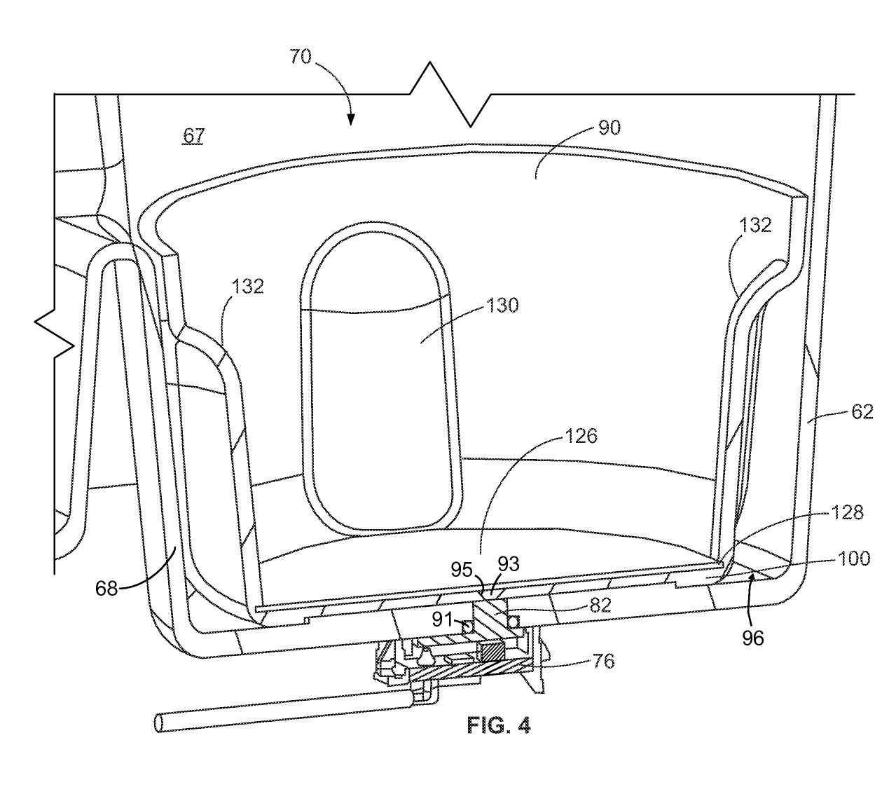

FIG. 4 is an expanded view of the area 4 shown in FIG. 2. The basket 90 includes a notch 93 formed therein. In one embodiment, the notch 93 may be conical. Alternatively, the notch 93 may have any suitable shape. The notch 93 includes a reflective surface 95. The reflective surface 95 is configured to direct light from the LED 82 through the basket 90. In one embodiment, the reflective surface 95 directs light from the LED 82 through the bottom wall 100 of the basket 90. The light directed through the bottom wall 100 of the basket 90 may propagate through the sidewall 102 of the basket 90. In one embodiment, the light propagates through the entire sidewall 102 of the basket 90. In another embodiment, the light propagates through only a portion of the sidewall 102 of the basket 90.

The basket 90 includes a cover 126 that extends across the bottom wall 100 of the basket 90. The cover 126 extends entirely along the bottom wall 100 of the basket 90. Alternatively, the cover 126 may extend partially across the bottom wall 100 of the basket 90. The basket 90 includes a recess 128 formed in the sidewall 102 of the basket. The recess is formed adjacent to the bottom wall 100 of the basket 90. The cover 126 extends into the recess 128. The recess 128 secures the cover 126 within the basket 90. The cover 126 may form a water tight seal with the recess 128 to prevent liquids from seeping under the cover 126. The cover 126 is configured to limit light from the bottom wall 100 of the basket 90. The cover 126 may include translucent and/or transparent designs and/or logos. The cover 126 may limit light from the basket 90 such that only the designs and/or logos glow, thereby displaying the designs and/or logos within the cavity 70. The designs and/or logos may also be colored to alter a color of the light from the LED 82.

The basket 90 is formed from a flexible material that enables the basket 90 to deform. For example, the basket 90 may be formed silicone, polyurethane, and/or polyethylene. The basket 90 deforms to accommodate different size containers. The basket 90 includes openings 130 and protrusions 132 that enable the basket 90 to deform. Each opening 130 is formed between adjacent protrusions 132. Each protrusion 132 is formed between adjacent openings 130. When a container is inserted into the basket 90 the protrusions 132 are configured to deform to accommodate different size containers. The protrusions 132 are configured to abut a side of the container to secure the container within the basket 90.

The basket 90 may be formed from a water resistant material so that the basket 90 is not damaged by condensation on the container and/or liquids within the container. In one embodiment, the bottom wall 100 of the basket 90 may form a water tight interface with the interior surface 96 of the bottom wall 66 to prevent liquids from seeping under the basket 90 and damaging the LED 82 and/or the power source 76. The cup holder 62 also includes an o-ring 91 that seals the LED 82 to the cup holder 62. The o-ring 91 provides a water tight interface that prevents water damage to the power source 76.

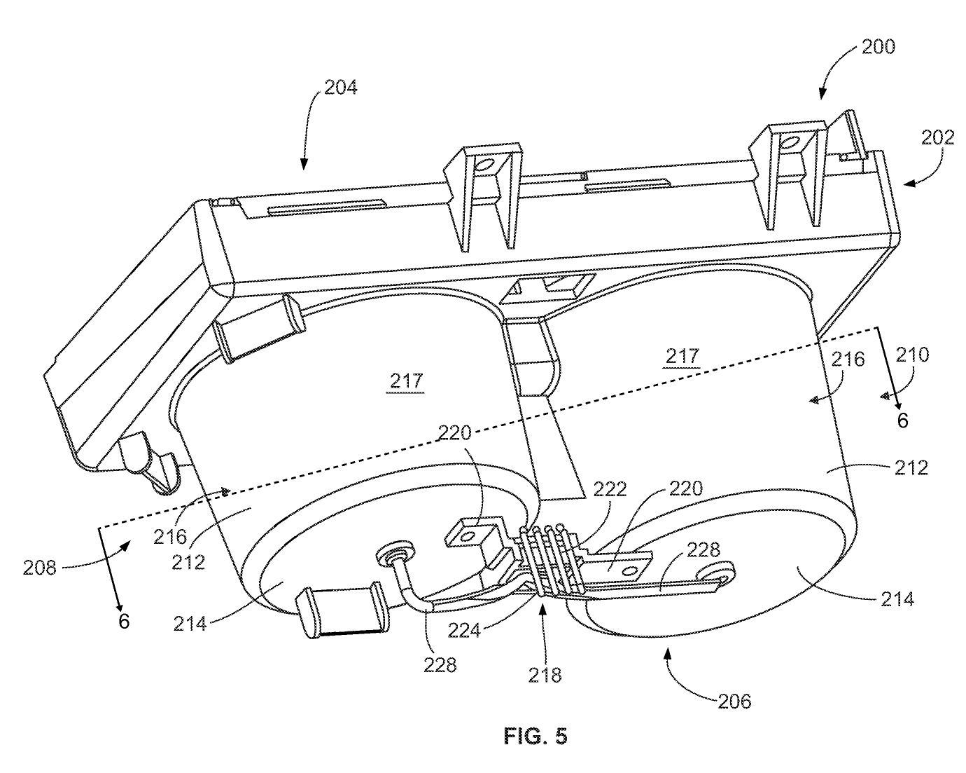

FIG. 5 illustrates a cup holder assembly 200 formed in accordance with an alternative embodiment. The cup holder assembly 200 includes a housing 202 having a top 204 and a bottom 206. The housing 202 includes a first end 208 and a second end 210. The cup holder assembly 200 includes cup holders 212. One cup holder 212 is positioned proximate to the first end 208 of the housing 202. Another cup holder 212 is positioned proximate to the second end 210 of the housing 202. The cup holders 212 include a bottom wall 214 and a sidewall 216. The bottom wall 214 is positioned proximate to the bottom 206 of the housing 202. The sidewall 216 extends from the bottom 206. The sidewall 216 includes an interior surface 215 and an exterior surface 217.

A LED assembly 218 is joined to the bottoms 214 of the cup holders 212. The LED assembly 218 includes support members 220. A support member 220 is joined to the bottom wall 214 of each cup holder 212. A power source 222 is joined to each support member 220. The power source 222 is positioned between the cup holders 212. Alternatively, the power source 222 may be positioned adjacent the bottom wall 214 of one of the cup holders 212. Wires 224 extend from the power source 222. The wires 224 are configured to electrically couple to a power system (not shown) of a vehicle (not shown). The wires 224 provide power to the power source 222.

A LED (not shown) is positioned on the LED assembly 218. The LED is joined to the power source 222. The power source 222 is configured to power and control the LED. A light guide 228 extends between the LED and the bottom wall 214 of the cup holder 212. The light guide 228 conveys light from the LED to the cup holder 212 to illuminate the cup holder 212.

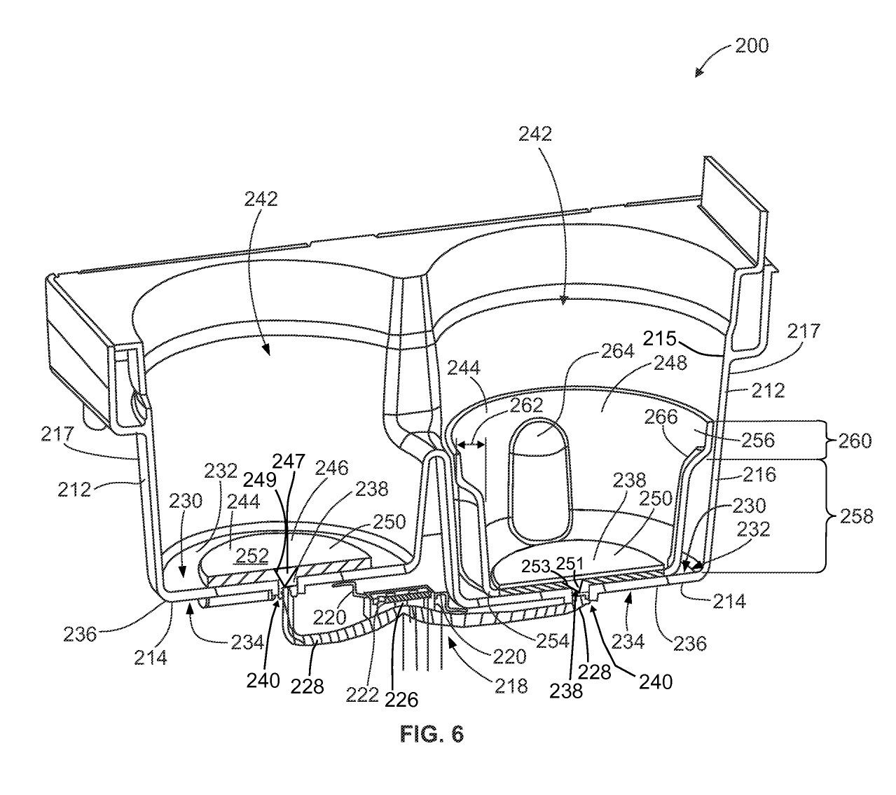

FIG. 6 illustrates a cut-away side view of the cup holder assembly 200 taken about line 6-6 of FIG. 5. The bottom wall 214 of each cup holder 212 includes a first side 230 having an interior surface 232 and a second side 234 having an exterior surface 236. The power source 222 of the LED assembly 218 is joined to the exterior surface 236 of the cup holders 212 via the support members 220.

The bottom wall 214 of each cup holder 212 includes an aperture 238 extending therethrough. The aperture 238 extends from the first side 230 to the second side 234 of the bottom wall 214 of the cup holder 212. The aperture 238 extends through the interior surface 232 and the exterior surface 236 of the bottom wall 214 of the cup holder 212. The light guides 228 extend through the apertures 238 in the bottom wall 214 of the cup holder 212. The light guides 228 pass through the interior surface 232 and the exterior surface 236 of the bottom wall 214 of the cup holder 212. The light guides 228 include a distal end 240. The distal end 240 of the light guides 228 is positioned flush with the interior surface 232 of the bottom wall 214 of the cup holder 212. Alternatively, the distal end 240 of the light guides 228 may extend beyond the interior surface 232 or be recessed within the bottom wall 214 of the cup holder 212. In one embodiment, the cup holder assembly 200 may include multiple light guides 228 extending through multiple apertures 238 formed in the bottom wall 214 of the cup holder 212. The light guides 228 are configured to transmit light from the LED to illuminate the cup holder 212.

Each cup holder 212 includes a cavity 242 defined by the bottom wall 214 and the sidewall 216 of the cup holder 212. The LED 226 is configured to illuminate the cavity 242. An insert 244 is positioned within each cavity 242. One or more inserts 244 may be formed as a disc 246 and/or a basket 248. The inserts 244 rest on the bottom wall 214 of the cup holder 212. The inserts 244 are formed from a translucent and/or transparent material and are configured to be illuminated by the LED 226 to illuminate the cavity 242. Each insert 244 includes a cover 250 that is configured to limit light from the insert 244. The cover 250 may include translucent and/or transparent designs and/or logos thereon.

The disc 246 extends partially along the interior surface 232. Alternatively, the disc 246 may extend entirely along the interior surface 232. The light guide 228 reflects light from the LED 226 toward the disc 246. The disc 246 includes a notch 247 formed therein. The notch 247 has a reflective surface 249 that is positioned and shaped to direct light from the LED 226 through the disc 246.

The disc 246 includes a planar surface 252. The planar surface 252 is configured to retain a container thereon. In one embodiment, the disc 246 is formed from a water resistant material to prevent condensation on the container and/or liquids within the container from damaging the disc 246. The disc 246 may form a water tight interface with the interior surface 232 to prevent liquids from seeping under the disc 246 and damaging the light guide 228 and/or the power source 222.

The basket 248 includes a bottom 254 and a sidewall 256. The sidewall 256 extends from the bottom 254. The bottom 254 of the basket 248 is positioned on the interior surface 232 of the bottom 254. The bottom 254 extends partially along the interior surface 232. Optionally, the bottom 254 of the basket 248 may extend entirely along the interior surface 232. The light guide 228 reflects light from the LED 226 toward the bottom 254 of the basket 248. The bottom 254 of the basket 248 includes a notch 251 formed therein. The notch 251 includes a reflective surface 253 that is positioned and shaped to reflect light from the LED 226 through the bottom 254 of the basket 248. In one embodiment, the light from the LED 226 may also propagate through the sidewall 256 of the basket 248. The light from the LED 226 may propagate through the entire sidewall 256 or only a portion thereof.

The basket 248 may be formed from a water resistant material. The bottom 254 of the basket 248 may form a water tight interface with the bottom wall 214 of the cup holder 212 to prevent liquids from damaging the light guide 228 and/or the power source 222.

The sidewall 256 of the basket 248 extends proximate to the interior surface 215 of the sidewall 216 of the cup holder 212. The sidewall 256 of the basket 248 includes a bottom portion 258 and a top portion 260. The bottom portion 258 extends from the bottom 254 of the basket 248. The top portion 260 extends from the bottom portion 258 toward the top 204 of the housing 202. The bottom portion 258 tapers outward to the top portion 260. The bottom portion 258 is spaced a distance 262 from the sidewall 216 of the cup holder 212. The distance 262 becomes smaller as the bottom portion 258 tapers toward the top portion 260. In one embodiment, the bottom portion 258 of the sidewall 256 may abut the interior surface 215 of the sidewall 216 of the cup holder 212. The top portion 260 of the sidewall 256 abuts the interior surface 215 of the sidewall 216 of the cup holder 212.

The basket 248 is formed from a flexible material to accommodate different size containers. The sidewall 256 of the basket 248 is configured to deform to accommodate different size containers. The sidewall 256 of the basket 248 includes openings 264 and protrusions 266. The openings 264 enable deformation of the protrusions 266. The protrusions 266 deform to accommodate different size containers. The protrusions 266 are configured to abut the side of a container to retain the container within the basket 248.

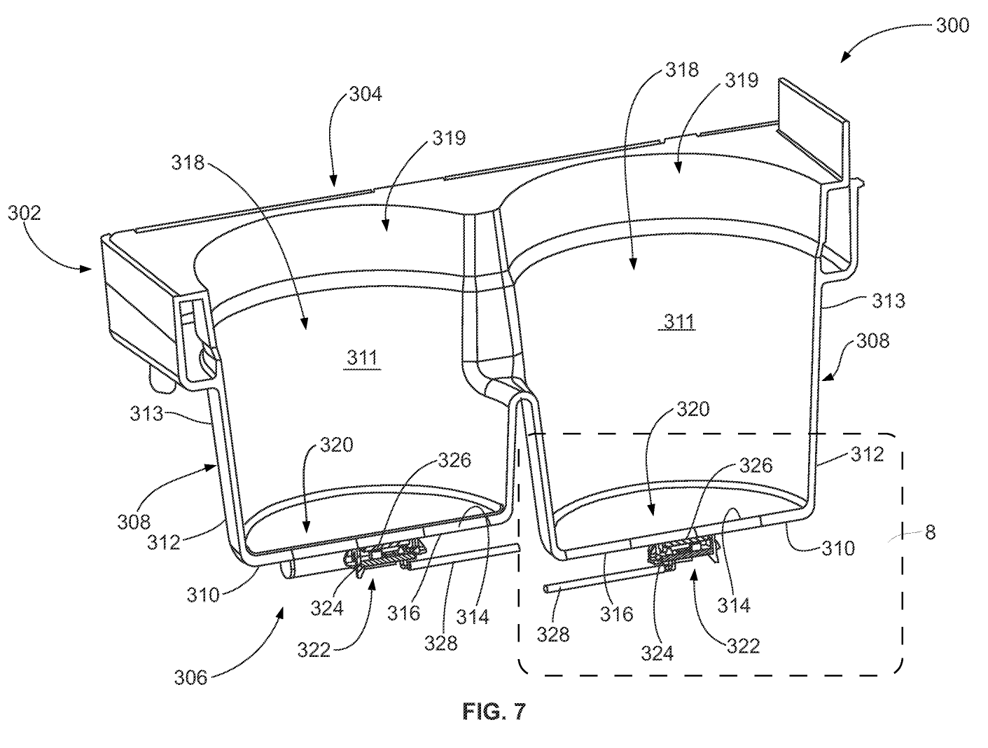

FIG. 7 illustrates a cut-away side view of a cup holder assembly 300 formed in accordance with an alternative embodiment. The cup holder assembly 300 includes a housing 302 having a top 304 and a bottom 306. Cup holders 308 extend between the top 304 and the bottom 306 of the housing 302. The cup holders 308 include a bottom wall 310 and a sidewall 312. The bottom wall 310 includes an interior surface 314 and an exterior surface 316. The sidewall 312 includes an interior surface 311 and an exterior surface 313. The bottom wall 310 and the sidewall 312 define a cavity 318. The interior surface 314 extends along a bottom 320 of the cavity 318. The cavity 318 has an opening 319 extending through the top 304 of the housing 302.

The cup holders 308 are formed from a translucent and/or transparent material capable of internally reflecting light. A LED assembly 322 is joined to the bottom wall 310 of each cup holder 308. The LED assembly 322 is joined to the exterior surface 316 of the bottom wall 310 of the cup holder 308. The LED assembly 322 includes a power source 324 and a LED 326. The power source 324 is configured to power and control the LED 326 to illuminate the cup holder 308. The LED 326 illuminates the cup holder 308 through internal reflections such that the cup holder 308 glows to light the cavity 318 of the cup holder 308. Wires 328 extend from the power source 324. The wires 328 are electrically coupled to a power system (not shown) and/or a battery (not shown). The wires direct an electrical signal to the power source 324 to power the power source 324.

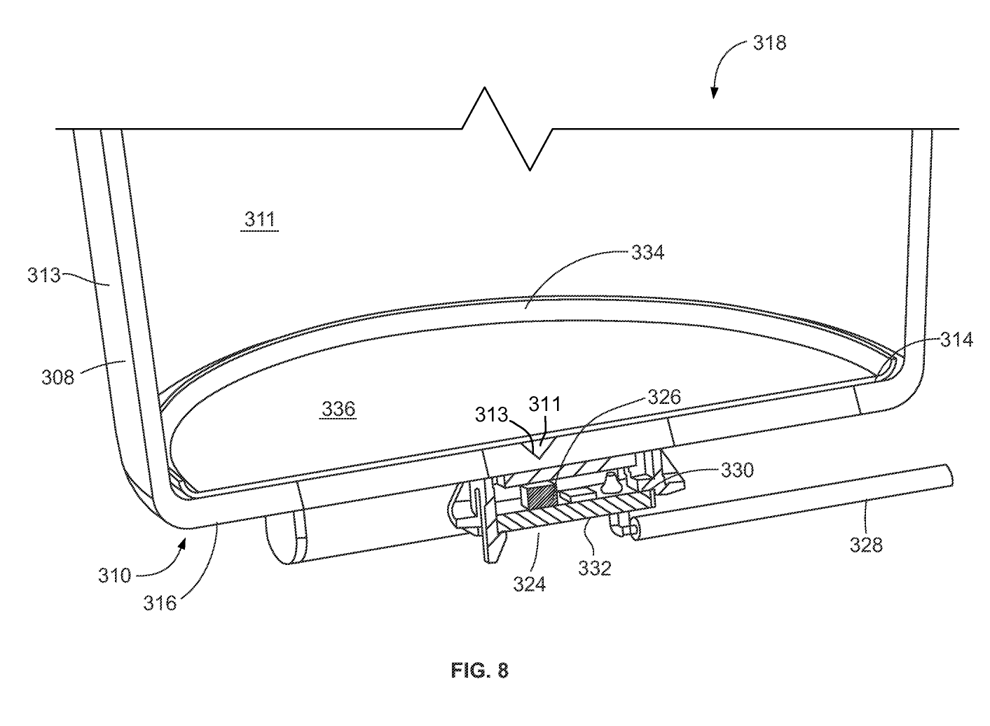

FIG. 8 illustrates an expanded view of the area 8 shown in FIG. 7. The power source 324 is joined to the exterior surface 316 of the bottom wall 310 of the cup holder 308. The power source 324 includes a top surface 330 and a bottom surface 332. The wires 328 extend from the bottom surface 332 of the power source 324. Optionally, the wires 328 may extend from the top surface 330 of the power source 324. The LED 326 is coupled to the top surface 330 of the power source 324. The LED 326 extends along the exterior surface 316 of the bottom wall 310 of the cup holder 308. The LED 326 may be joined to the exterior surface 316. In another embodiment, the LED 326 may abut the exterior surface 316.

The bottom wall 310 of the cup holder 308 has a notch 311 formed therein. The notch 311 includes a reflective surface 313 that is configured to reflect light from the LED 326 through the bottom wall 310 of the cup holder 308. In one embodiment, the light from the LED 326 propagates through the sidewall 312 of the cup holder 308. The light from the LED 326 may propagate through the entire sidewall 312 of the cup holder 308 or only partially therethrough.

In one embodiment, more than one LED 326 may be positioned along the bottom wall 310 of the cup holder 308. Multiple LEDs 326 may be configured with different colors. The LEDs 326 may be selectively operable to illuminate the cavity 318 of the cup holder 308 with a desired color. Multiple LEDs 326 may be configured to operate in sequence to change a color of the cavity 318. In another embodiment, multiple LEDs 326 may operate concurrently to provide additional illumination to the cavity 318. Alternatively, multiple LEDs 326 may selectively operate in sequence, concurrently, or one or more at a time.

In the illustrated embodiment, a cover 334 is positioned on the interior surface 314 of the cup holder 308. The cover 334 extends entirely along the interior surface 314. Alternatively, the cover 334 may extend partially across the interior surface 314. The cover 334 is configured to limit light from the bottom wall 310 of the cup holder 308. The cover 334 may include translucent and/or transparent designs and/or logos. Light from the bottom wall 310 of the cup holder 308 may propagate through the designs and/or logos, thereby displaying the designs and/or logos within the cavity 318. The designs and/or logos may also be colored to alter a color of the light from the LED 326.

The cover 334 has a planar surface 336. The planar surface 336 is configured to retain a container thereon. The cover 334 may be formed from a water resistant material that protects the cover from condensation and/or other liquids on and/or within the container positioned on the planar surface 336. The cover 334 may form a water tight interface with the interior surface 314 of the cup holder 308. The water tight interface may prevent liquids from seeping under the cover 334. Preventing liquids from seeping under the cover 334 may prevent the cover from peeling off of the interior surface 314. The water tight interface may prevent mildew and/or mold from forming under the cover 334.

The embodiments described herein provide a cup holder assembly having a LED assembly that is built into a cup holder to illuminate a cavity of the cup holder. The LED assembly is positioned beneath the cup holder and is out of view from an operator of the vehicle. The LED assembly does not require additional cables and/or wires that may interfere with the operation of the vehicle. The LED assembly provides lighting for the entire cavity of the cup holder. The LED assembly may be selectively adjusted to provide different colors and/or sequences of colors. The LED assembly may also be configured with logos and/or designs that are illuminated within the cup holder. In one embodiment, the inserts of the cup holder assembly are water resistant and/or form a water tight seal with the cup holder. The water tight seal protects the LED assembly from damage. The cup holder assembly also limits mold and/or mildew that may be caused by water seeping into crevices formed in the cup holder assembly.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A cup holder comprising:
a body having bottom wall and a sidewall extending from the bottom wall, a cavity defined by an interior surface of the bottom wall and an interior surface of the sidewall;
a power source joined to an exterior surface of the bottom wall of the body, the exterior surface of the bottom wall of the body opposite the interior surface of the bottom wall of the body;
a LED electrically coupled to the power source; and
a reflective surface configured to direct light from the LED along the bottom wall of the body.

2. The cup holder of claim 1, wherein the reflective surface is formed in the bottom wall of the body, the reflective surface directing light from the LED through the bottom wall of the body.

3. The cup holder of claim 1 further comprising an insert formed as a disc that extends at least partially along the interior surface of the bottom wall of the body, the reflective surface formed in the insert, the reflective surface directing light from the LED through the insert.

4. The cup holder of claim 1 further comprising an insert including:
a bottom wall extending at least partially along the interior surface of the bottom wall of the body; and
a sidewall extending from the bottom wall of the insert, the sidewall of the insert extending along the interior surface of the sidewall of the body, the reflective surface formed in the insert, the reflective surface directing light from the LED through the insert.

5. A cup holder comprising:
a body having a bottom wall and a sidewall, a cavity defined by an interior surface of the bottom wall of the body and an interior surface of the sidewall of the body;
a power source joined to bottom wall of the body;
a LED electrically coupled to the power source; and
an insert positioned on the interior surface of the bottom wall of the body, the insert having a reflective surface formed therein, the reflective surface directing light from the LED through the insert.

6. The cup holder of claim 5 further comprising a light guide configured to direct light from the LED to the reflective surface.

7. The cup holder of claim 5, wherein the insert includes a disc that extends at least partially along the interior surface of the bottom wall of the body.

8. The cup holder of claim 5, wherein the insert extends at least partially along the interior surface of the sidewall of the body.

9. The cup holder of claim 5, wherein the insert is configured to retain a container, the insert being flexible to accommodate containers having different sizes.

10. The cup holder of claim 5 further comprising multiple LEDs configured to direct light to the reflective surface.

11. The cup holder of claim 5, further comprising a cover positioned on at least a portion of the insert, at least a portion of light from the LED reflected through the cover.

12. The cup holder of claim 5, wherein the bottom wall of the body includes an exterior surface opposite the interior surface of the bottom wall of the body, the power source coupled to the exterior surface of the bottom wall of the body.

13. The cup holder of claim 5, wherein the insert includes:
a bottom positioned proximate to the bottom wall of the body, the bottom of the insert having a bottom diameter;
a top having a top diameter, the top diameter greater than the bottom diameter; and
a sidewall extending between the top and bottom, the sidewall tapered outward from the bottom diameter to the top diameter.

14. A lighting system for a cup holder, the lighting system comprising:
a power source configured to join to an exterior surface of a bottom wall of the cup holder;
a LED electrically coupled to the power source; and
an insert configured to position on an interior surface of the bottom wall of the cup holder, the insert having a reflective surface formed therein, the reflective surface directing light from the LED through the insert.

15. The lighting system of claim 14 further comprising a light guide configured to direct light from the LED to the reflective surface.

16. The lighting system of claim 14, wherein the insert includes a disc configured to extend at least partially along the interior surface of the bottom wall of the cup holder.

17. The lighting system of claim 14, wherein the cup holder includes a sidewall, the insert configured to extend at least partially along an interior surface of the sidewall of the cup holder.

18. The lighting system of claim 14, wherein the insert is configured to retain a container, the insert being flexible to accommodate containers having different sizes.

19. The lighting system of claim 14 further comprising multiple LEDs, the multiple LEDs configured to at least one of illuminate concurrently or illuminate in sequence.

20. The lighting system of claim 14, wherein the insert includes:
a bottom configured to be positioned proximate to the bottom wall of the cup holder, the bottom having a bottom diameter;
a top having a top diameter, the top diameter greater than the bottom diameter; and
a sidewall extending between the top and bottom, the sidewall tapered outward from the bottom diameter to the top diameter.
